(19) United States
(12) Patent Application Publication
(10) Pub. No.: US 2005/0099657 A1
(43) Pub. Date: May 12, 2005

(54) System and method for producing personalized imaged material

(75) Inventor: Peter R. Hudetz, Naperville, IL (US)

Correspondence Address: Jasper W. Dockrey;Brinks Hofer Gilson & Lione, NBC Tower, Suite 3600, P.O. Box 10395, Chicago, IL, 60610, US

(73) Assignee: Solar Communications, Inc.

(21) Appl. No.: 10/712,291

(22) Filed: Nov. 12, 2003

(51) Int. Cl. G06F 15/00

(52) U.S. Cl. 358/1.18; 358/1.12

(57) ABSTRACT

A system and method for producing personalized imaged material includes selectively gathering stock sheets and assembling the stock sheets into designated sets of sheets. The stock sheets in each designated set of sheets are sequentially processed to image personalized information onto each stock sheet. The personalized sheets are re-gathered into the designated sets of sheets and presented for final processing. Processing is carried out by collators, re-feeders, variable data imaging systems, and finishing systems. Operational control is provided by a control system that includes a data structure containing user information and recipient profile information. An operations controller executes job requests for a particular user and accesses recipient profiles to image personalized information onto the stock sheets. The system and method are useful for direct marketing, invoicing, document preparation, preparation of personalized books, and the like.

### TECHNICAL FIELD

The present invention relates, generally, to collation and selective insertion of imaged material, and more particularly, to systems and methods for dynamic insertion and custom finishing of printed material.

### BACKGROUND

With the advent of computer technology, a wide variety of processing and handling system are now available to produce customized printed material. High volume production of selectively inserted printed material and packaging of the printed material can now be performed by computer-controlled equipment. Large volume production of advertising materials, account statements, and bulk mailing can be carried out using high-volume collation and packaging systems. For example, bulk mailing systems can place several enclosures or inserts into packages intended for mailing to selected recipients. The packages typically include common items that are sent to all recipients and additional items inserted into the package for selected recipients. The creation of mailing packages containing individualized inserts can only be realized on a cost-effective basis through the use of automated, high-speed equipment.

The preparation of individualized packages of printed material requires the use of scanning technology for product quality control. Typically, selective insertion systems employ machine readable indicia printed on control documents to ensure the proper printed materials are enclosed within a designated package. In one such system, selected inserts are placed into billing statements under the control of an integrated system controller. The controller directs selective insertion of enclosures into the billing statements. The system controller directs the inserter to selectively include inserts with the billing statement according to instructions from a data processor.

Selective insertion systems are also used to place inserts into bulk mailing items, such as advertising mailers and advertising inserts within newspapers. In one such system, newspapers are collated with materials that vary depending upon the product interest of selected newspaper subscribers. In addition to placing selective inserts within the newspaper, the system also prints indicia identifying the selected subscriber on a jacket of the newspaper.

High-speed, computer-controlled processing equipment is also used for permit and pre-sort bulk mailing for delivery to the U.S. Postal Service. Scanning equipment is used to pre-sort bulk mailings and to inspect and verify that mail pieces have been properly pre-sorted and proper postage applied. Such systems include stacking structures for accommodating a plurality of like stationery items. Printing systems are used to print various parts of information stored by a computer system on selected stationery items from the stacking structure. Identification marks are placed on the stationery items for use by the U.S. Postal Service for marking and identifying pre-sorted letters.

Automated systems have also been developed that validate the sequence and package completeness of output from a high-speed printer. The equipment can add covers and inserts and, if required, bind the printed material together in a variety of ways and place the printed material in a package. The systems are configured to assemble a variety of documents, such as insurance policies, contracts, instructional materials, parts and repair manuals, and business reports of various types. For example, the system can place particular clauses within insurance policies that are to be selectively mailed to policy holders residing in a particular state. The automated printing and assembly equipment thus enables large volume distribution of insurance policies and other documents that contain particular information relevant to selected recipients.

Although computer controlled systems have enable development of high-volume printed material handling systems, systems and methods have yet to be developed to address the particular need for individualized finished printed material. Further, advancements in system configuration are necessary to fully realize the potential of advanced printing and handling systems. Accordingly, a need existed for systems and methods to address a wide variety of applications for personalized printed material and finishing of the printed material.

### SUMMARY

In one embodiment of the invention, a method for producing personalized printed material includes selectively gathering stock sheets and assembling the stock sheets into designated sets of sheets. The stock sheets in each designated set of sheets are sequentially processed to image personalized information onto each stock sheet. The stock sheets are then regathered into the designated sets of sheets and the designated sets of sheets are presented for final processing.

In another embodiment of the invention, a method for producing personalized printed material includes assembling target information into a database and creating general and specific information files. The general information files are used to selectively collate pre-printed sheets into designated sets of sheets. The pre-printed sheets from each designated set of sheets are individually fed to an imaging system. Personalized information is imaged onto each pre-printed sheet using the specific information files. The pre-printed sheets are regathered into the designated sets of sheets and the designated sets of sheets are presented for final processing.

In yet another embodiment of the invention, a system for producing personalized printed material includes a collator coupled to a re-feeder. The collator is configured to selectively gather stock sheets and to assemble the stock sheets into designated sets of sheets. An imaging system is coupled to the re-feeder and is configured to image the personalized information onto the stock sheets to produce personalized sheets. A reassembly station is coupled to the imaging system and is configured to re-gather the personalized sheets into the designated sets of sheets. A final process system is coupled to the re-assembly station and configured to perform one or more of binding, attaching, or packaging the designated sets of sheets. A control system provides control signals for processing and imaging the stock sheets.

In still another embodiment of the invention, a system for producing personalized printed material includes a first collator coupled to a first re-feeder. The first collator is configured to selectively gather pre-printed sheets and to assemble the pre-printed sheets into designated sets of primary sheets. A first imaging system is coupled to the first re-feeder. The first imaging system is configured to image information onto the pre-printed primary sheets. A second collator is coupled to a second re-feeder. The second collator is configured to selectively gather pre-printed insert sheets and to assemble the pre-printed insert sheets into designated sets of insert sheets. A second imaging system is coupled to the second re-feeder. The second imaging system is configured to image information onto the pre-printed insert sheets. A reassembly station is coupled to the first and second imaging systems and is configured to re-gather the pre-printed primary sheets into the designated sets of primary sheets and to re-gather the pre-printed insert sheets into the designated sets of insert sheets. A merging station is coupled to the reassembly station and configured to merge the designated sets of insert sheets into the designated sets of primary sheets to provide final sets of sheets. A final process system is configured to perform one or more of binding, attaching, or packaging the final sets of sheets.

### BRIEF DESCRIPTION OF THE DRAWING

FIG. 1a is a front view of an exemplary pre-printed sheet that may be used as a stock sheet in accordance with the invention;

FIG. 1b is a front view of the stock sheet illustrated in FIG. 1a having personalized information printed thereon;

FIG. 2a is a front view of an insert sheet that may be used as an addressing vehicle in accordance with the invention;

FIG. 2b is a front view of the insert sheet illustrated in FIG. 2 having personalized information printed thereon in accordance with the invention;

FIG. 3a is a schematic block diagram of a control system arranged in accordance with the invention;

FIG. 3b is a schematic block diagram of a general information file structure in accordance with the invention;

FIG. 3c is a schematic block diagram of customer data files in accordance with the invention;

FIG. 4a is a schematic diagram of two exemplary collation systems arranged in accordance with the invention;

FIG. 4b is a schematic diagram of a re-feeder, an imaging system, and a re-gathering system arranged in accordance with the invention;

FIG. 4c is a top view of the schematic diagram illustrated in FIG. 4b and including additional components of a packaging system arranged in accordance with the invention;

FIG. 4d is a schematic diagram of an insertion system, an imaging system, and a portion of a packaging system arranged in accordance with the invention;

FIG. 5 is a flow diagram illustrating a process control sequence for a single-lane machine in accordance with the invention;

FIG. 6 illustrates another embodiment of a process control sequence for a single-lane machine in accordance with the invention;

FIG. 7 illustrates a process control sequence for a single-lane machine arranged in accordance with a further embodiment of the invention;

FIG. 8 is a schematic top view of a dual-lane machine arranged in accordance with one embodiment of the invention;

FIG. 9 is a schematic top view of a dual-lane machine arranged in accordance with another embodiment of the invention;

FIG. 10 is a flow diagram of a process control sequence for a dual-lane machine in accordance with the invention; and

FIG. 11 illustrates a process control sequence for a dual-lane machine in accordance with another embodiment of the invention.

It will be appreciated that for simplicity and clarity of illustration, machine elements shown in the Figures have not necessarily been drawn to scale. For example, the dimension of some of the elements are exaggerated relative to others for clarity. Further, where considered appropriate, reference numerals have been repeated among the Figures to indicate corresponding elements.

### DETAILED DESCRIPTION

The present invention provides a system and method for low-cost, high-volume production of personalized printed materials. A computerized processing system enables a wide range of imaged materials to be automatically processed and packaged for delivery to recipients. The system and method of the invention can be utilized to address numerous applications including, but not limited to, direct marketing, invoice preparation, customized documentation preparation, and the like. The computer control processing system enables the storage of large quantities of information concerning various aspects of the recipients of the personalized imaged materials. The computerized control system also enables storage of user information that can be selectively coupled with recipient information to provide personalized imaged materials to selected recipients based on user criteria and recipient data files.

As will become apparent from the following description, the various embodiments of the invention are designed with maximum flexibility to enable the use of the system for a wide variety of applications and the preparation of small and large volume imaged material production. Although the exemplary embodiments of the invention described below generally relate to direct marketing, those skilled in the art will appreciate that the system and method of the invention can equally be applied to a wide variety of different imaged materials.

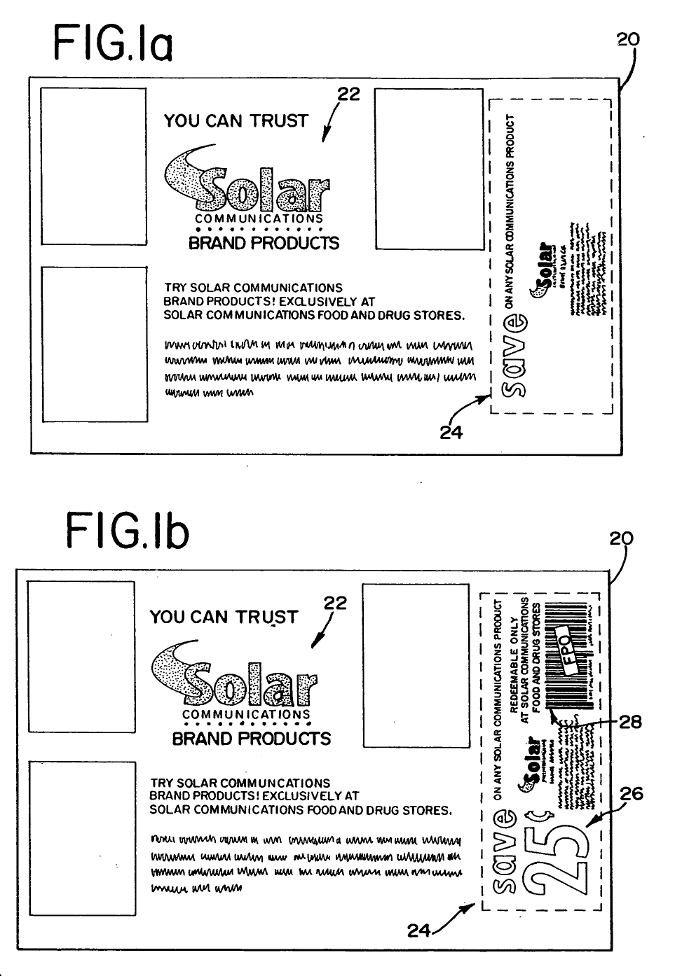

Shown in FIG. 1a is a front view of a pre-printed sheet 20. In the illustrative embodiment, pre-printed sheet 20 includes indicia 22 showing the source of the pre-printed sheet, in this instance Solar Communications, Inc., the assignee of the present invention and a coupon blank 24. In accordance with the invention, pre-printed sheet 20 can be one of many such pre-printed sheets having a variety of coupon blanks and different provider indicia. The provider indicia can vary in a number of ways including different products, different advertising information, and different providers, which may be divisions of a single business entity or different business entities.

FIG. 1b is a front view of pre-printed sheet 20 after processing in the system of the invention to image personalized information thereon. In accordance with one aspect of the invention, pre-printed sheet 20 has been subjected to an imaging process to place customized indicia 26 and 28 on coupon blank 24. As a result of the imaging process, coupon blank 24 now includes a particular value, shown as indicia 26, and a barcode, shown as indicia 28, for identification and tracking purposes. By processing pre-printed sheet 20 through the imaging system of the invention, a stock sheet has been processed to place personalized information onto the stock sheet. In accordance with the invention, numerous additional customized or personalized indicia can be imaged onto pre-printed sheet 20. For example, specific products, additional pricing information, and the like, could also be imaged on pre-printed sheet 20.

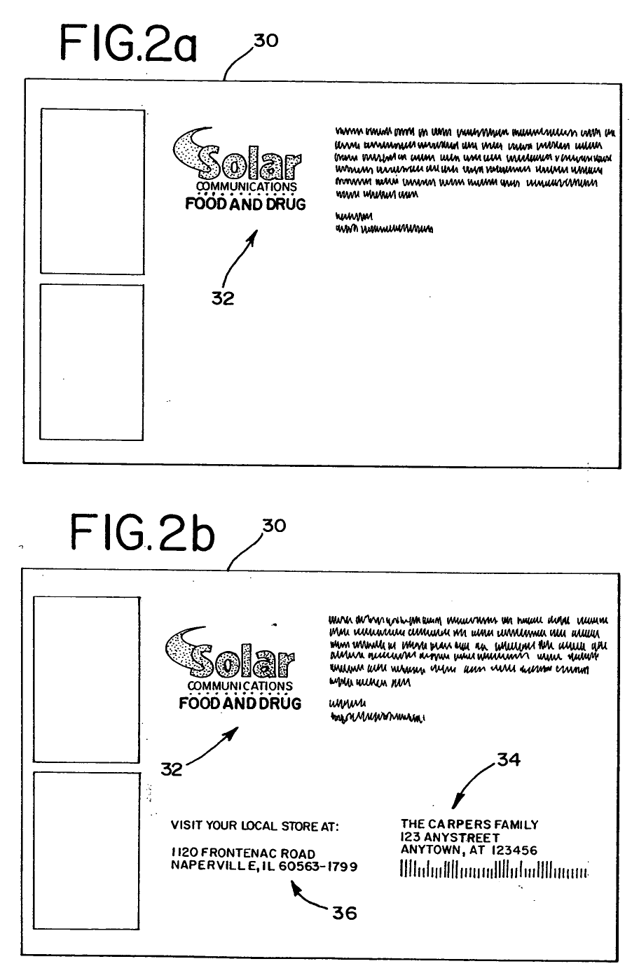

A front view of an exemplary insert sheet 30 is illustrated in FIG. 2a. Insert sheet 30 includes provider indicia 32. Insert sheet 30 can be one of a number of different inserts, including an addressing insert for mailing purposes, a special insert identifying additional products or services, and the like. In the aspect of the invention where insert sheet 30 functions as an addressing vehicle, personalized information in the form of a recipient address 34 is placed on insert sheet 30, as illustrated in FIG. 2b. Additionally, further provider information 36 can also be imaged onto insert sheet 30 prior to packaging. Those skilled in the art will appreciate that numerous additional indicia can also be imaged onto insert sheet 30 including additional provider information, package opening incentives, and the like.

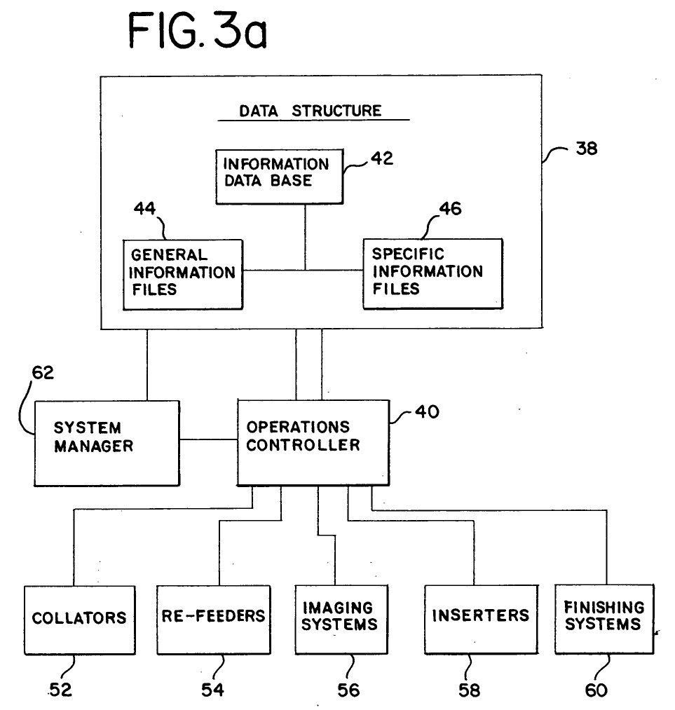

A computer control system for preparing personalized printed material in accordance with the invention is illustrated in FIG. 3a. The control system includes a data structure 38 that is interfaced to an operations controller 40. Data structure 38 includes an information database that includes a wide variety of provider and recipient information. The provider information can include source identification information, brand information, specific product information, market pricing, and discount information, and the like. The information database can also include recipient information, such as identification, product preferences, store preferences, geographic location, and the like. In another aspect of the invention, information database 42 can include information relating to additional applications of the invention, such as invoicing, custom document preparation, preparation of personalized books, and the like. Where the provider is, for example, a service company, such as a utility company, the provider information can include regional rate information, billing code information, invoice routing information, and the like. The recipient information could include annual usage information, special fees or rate information, rate discount information, and the like. Further, where the provider is a book publisher or distributor, the recipient information could include, for example, names for insertion into personalized books, such as, for example, children's books, and the like.

In accordance with the invention, the assembled information in information database 42 is organized into general information files 44 and specific information files 46. FIG. 3b illustrates an example of the file organization within general information files 42. The file database includes user profile data 48 and various topic category files 50. The content of user profile data 48 will depend upon the particular business activity of the user, in addition to the number and type of user locations, the particular products or services offered by the user, and the like. Topic category 50 can include particular product information, such as product type, product brand, general pricing information, such as discounts, and the like.

Specific information files 46 can include numerous data relating to specific recipients of the personalized printed materials. As illustrated in FIG. 3c, the recipient data files can include identification information, specific pricing applying to a specified recipient or groups of recipients, product preferences for individual recipients and groups of recipients, store preferences of individual recipients, geographic location of particular recipients, and the like.

Those skilled in the art will appreciate that the architecture of data structure 38 described above is but one of many different possible architectures of a data structure for the present invention. Depending upon the particular application of the present invention, data structure 38 can have additional information files from those described above. For example, additional information files can include regulatory information, statutory information, and the like. In accordance with the invention, as illustrated in FIG. 3a, operations controller 40 is interfaced with a variety of processing systems used in the production of personalized imaged material.

Operations controller 40 provides command and control instructions to one or more collators 52, refeeders 54, imaging systems 56, inserters 58, and finishing systems 60. Operations controller 40 responds to commands to provide personalized printed materials intended for particular recipients as requested by specific users.

A system manager 62 responds to input instructions from operations personnel and instructs operations controller 40 to prepare sets of personalized printed material using particular data files maintained in data structure 38. System manager 62 initiates and maintains all of the data files within data structure 38 and, accordingly, maintains an awareness of the status of all data files in data structure 38.

Those skilled in the art will appreciate that the functions of system manager 62 and operations controller 40 can be carried out by electronic devices, such as microprocessors, microcontrollers, and the like. Further, the databases maintained in data structure 38 can be stored in hard memory devices, such as dynamic-random-access-memory (DRAM), static-random-access-memory (SRAM), on-board memory structures, and the like. System operators can enter command instructions to system manager 62 and data into data structure 38 through any of a number of different input/out devices, such as computer terminals, voice-activated systems, scanning devices, and the like.

Upon receiving instructions in the form of a job request from system manager 62, operations controller 40 matches the job request information with user profile data 48 and topic category files 50 with one or more recipient data files in specific information files 46. Once the user information and recipient information is matched, operations controller 40 relays command signals to the various operating equipment to produce the requested personalized printed material.

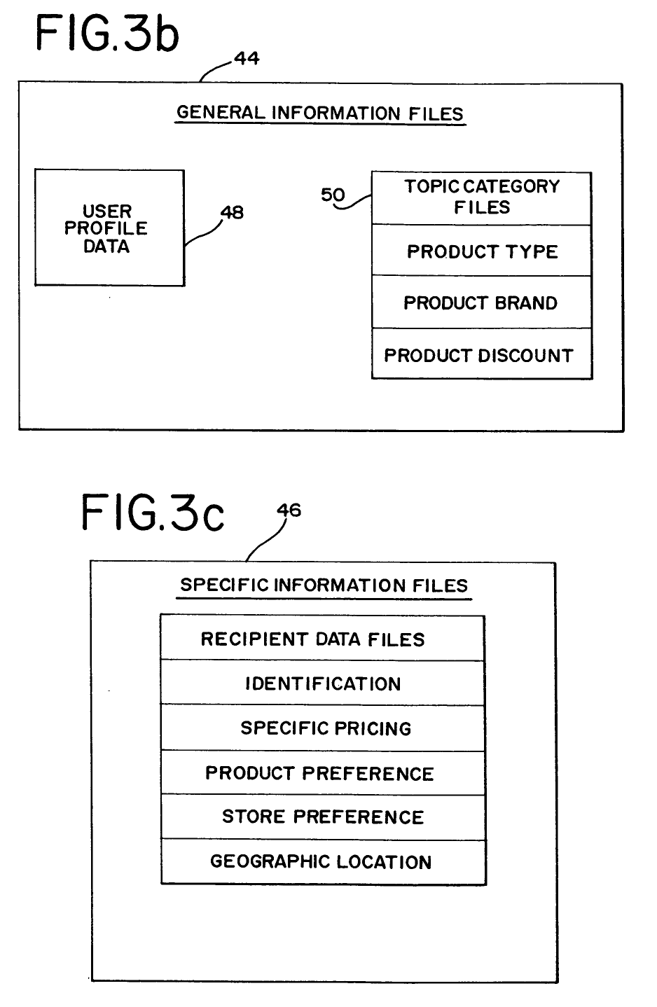

FIGS. 4a-4d illustrate one embodiment of a single-lane machine for practicing the present invention. The various components making up the single-lane machine include a collator 70, a re-feeder 72, an imaging system 74, a re-gathering system 76, and a finishing system 78. The single-lane machine can also include an insertion system 80 and a second imaging system 82.

In accordance with the invention, collator 70 can be one of several different types of collators. Two exemplary collators are schematically illustrated in FIG. 4a. A vacuum and rotary feed collator 84 includes a bin 86 that gravity feeds stock sheets 88 to a rotary feed device 90. Rotary feed device 90 in conjunction with a belt 92 sequentially feeds stock sheets 88 onto the spaces between conveyor lugs 94. Conveyor lugs 94 are distributed along conveyor belt 96. As conveyor belt 96 moves in a lateral direction from left to right, rotary feed device 84 feeds stock sheets 88 onto the space between conveyor lugs 94 in response to commands received from operations controller 40 through a system relay 98. System relay 98 activates rotary feed device 84 in response to instructions from operations controller 40 and returns operational status information to operations controller 40.

In accordance with one embodiment of the invention, a number of rotary feed systems 84 are positioned above and laterally distributed along conveyor belt 96. Each of the rotary feed systems supplies a stock sheet from its bin onto select trays on conveyor belt 96. After a tray has passed beneath several rotary feed systems 84, a designated set of sheets 100 is assembled on a tray of conveyor belt 96. The make-up of designated set 100 depends upon the particular activation sequence of rotary feed system 84 as conveyor belt 96 moves in a generally left to right direction. Those skilled in the art will recognize that rotary feed systems 84 could also be positioned along side of conveyor belt 96 and feed stock sheets either at a right angle to the direction of motion of conveyor belt 96 or in the same direction of motion. As described above, operations controller 40 responds to commands from operations personnel and uses information in data structure 38 to initiate activation signals to the various rotary feed systems of the collator.

A friction feed collator 102 is also illustrated in FIG. 4a. Friction feed collator 102 includes a bin 104 containing stock sheets 88. A friction belt 106 grabs stock sheets that are released from bin 104 and feeds the stock sheets through a feed conveyor system 108 onto the spaces between conveyor lugs 94. In similarity to rotary feed collator 84, friction feed collator 102 includes a number of friction feed systems positioned above and laterally distributed along conveyor belt 96. Each friction feed system is equipped with a system relay 110 that receives instructions from operations controller 40 and sends operation status information back to operations controller 40. Those skilled in the art will recognize that friction feed systems could also be positioned along side of conveyor belt 96 and feed stock sheets either at a right angle to the direction of motion of conveyor belt 96 or in the same direction of motion.

Conveyor 96 transfers designated set 100 to a pick-up system 112. As illustrated in FIG. 4b, pick-up system 112 is a component of re-feeder 72. Re-feeder 72 also includes a bin 114 and friction feed belt 116. Designated sets 100 are loaded into bin 114 and individual stock sheets are sequentially fed by friction feed belt 116 through transfer system 118 and into aligning system 120. Re-feeder 72 sequentially feeds stock sheets into aligning system 120 upon commands received through a system relay 122 from operations controller 40.

In accordance with the invention, re-feeder 72 is configured to operate at transfer rates substantially greater than the operational rate of collator 70. In a preferred embodiment of the invention, re-feeder 72 operates at a rate that is about 2 to about 50 times faster than collator 70. The high operating speed of re-feeder 72 ensures that designated sets 100 transferred from collator 70 can be sequentially processed at a rate that will accommodate the large number of stock sheets 88 contained within each designated set 100.

Aligning system 120 aligns each stock sheet 88 to position each stock sheet at a proper orientation for imaging by imaging system 74. Once aligned by alignment system 120, stock sheets 88 are transferred to a vacuum belt 124 in imaging system 74. As each stock sheet 88 is transferred to vacuum belt 124, a scanning device 126 scans the stock sheet for a code or other graphic indicia to ensure that the correct stock sheet will be presented to imaging system 74. Scanning device 126 sends optical signals to a digital signal converter 128 that relays scan information to operations controller 40. Operations controller 40 verifies that the stock sheet 88 is a proper member of designated set 100 prior to imaging personalized indicia onto stock sheet 88 by imaging system 74. If scanning device 126 detects an incorrect sheet, imaging system 74 diverts the sheet to a waste bin (not shown) and operations controller 40 reorders the set of sheets containing the incorrect sheet.

Vacuum belt 124 positions stock sheet 88 within the imaging field of an imaging device 130. Imagine device 130 can be one of a number of different imaging devices including a variable data imaging system, a laser printer, an ink jet printer, and the like. In a preferred embodiment of the invention, imaging device 130 is a solvent-based ink jet system that can image stock sheets at a conveyor speed of about 500 to about 1000 linear feet per minute. Imaging system 130 is preferably a system configured to image stock sheets 88 from a position immediately above the stock sheets. Alternatively, imaging system 130 can also image stock sheets 88 from a position immediately below the stock sheets. In accordance with the invention, imaging device 130 also includes an imaging control system 131 and vacuum system 132 that provides vacuum pressure for vacuum belt 124.

Preferably, re-feeder 72 and imaging system 74 operates at a speed that is consistent with the demand for individually processing the stock sheets within a designated set 100 that contains a maximum number of stock sheets. At such an operating speed, the number of stock sheets in each designated set can vary, while the linear speed of vacuum belt 124 remains constant. For example, where a designated set 100 contains three stock sheets and another designated set 100 contains seven stock sheets, operations controller 40 will instruct re-feeder 72 to skip four feeds, plus a number for buffer purposes when processing the three-sheet designated set. Operations controller 40 also instructs refeeder 72 to skip a certain number for buffer purposes when processing the designated set containing seven stock sheets. The insertion of buffers when processing designated sets 100 having different numbers of stock sheets allows time, if needed, for the re-gathering of the designated sets and transferring the designated sets to final processing. The number of buffer positions depends on the overall operating speed of the single-lane machine.

As will subsequently be described, in an alternative embodiment, re-feeder 74 and imaging system 72 can operate at a variable feed rate. After stock sheets 88 are imaged to contain personalized information, they are transferred to re-gathering system 76 and reassembled into the original designated sets initially prepared by collator 70. Where needed for final processing purposes, re-gathering system 76 can include a rotary indexing device 134 that delivers re-gathered designated sets 100 to a conveyor 136. Stations 138 within rotary indexing device 134 rotate into alignment with vacuum belt 124 and receive personalized sheets 89 from imaging system 74. Alternatively, another type of indexing and turn over device, such as a belt system and the like can also be used. In yet another alternative, re-gathering system does not include a turn over device. Those skilled in the art will appreciate that the re-gathering system illustrated in FIGS. 4b-4d is one of many different possible equipment configurations for re-gathering the sheets processed by imaging system 74.

Once re-gathered and indexed, the designated sets of personalized sheets 101 can be transferred to a number of finishing operations. Those skilled in the art will appreciate that numerous types of finishing procedures can be carried out to organize the designated sets of sheets into a user specified format. For example, the designated sets of sheets can be bound together or attached using some other physical attachment means, such as clips, pins, staples, glue, and the like. Also the designated sets of sheets can be packaged by overwrapping, or shrink wrapping, or the like. Additionally, the designated sets of sheets can be inserted into an envelope suitable for mailing with the U.S. Postal Service or another document delivery service. In the machine embodiment illustrated in FIGS. 4a-4d, the single-lane machine is arranged to insert index sets of sheets 101 into envelopes 140.

As described above, the single-lane machine can also include insertion system 80 and second imaging system 82. Insertion system 80 includes a bin 142 that contains insert sheets 144. Insert sheets 144 can be any of a number of different types of sheets having a variety of information imaged thereon. In the embodiment of the invention described with reference to FIGS. 1 and 2, insert sheets 144 are intended to provide address information for particular recipients in addition to user information.

Upon receiving control signals from operations controller 40, system relay 146 command insertion system 80 to transfer an insert sheet 144 from bin 142 through transport system 148 to second imaging system 82. Second imaging system 82 includes an imaging device 150 that receives image control commands from operations controller 40 through imaging control system 152. Second imaging system 82 also includes an alignment system 154 to properly align insert sheets 144 within the imaging field of imaging device 150. In similarity with imaging device 130, imaging device 150 can be a variable field imaging system, or printing system, such as a laser printer or a inkjet printer, or the like. In a preferred embodiment of the invention, imaging device 150 is an inkjet printing system.

Once personalized information has been imaged onto insert sheet 144, the second imaging system 182 transfers the insert sheet to a selected station within rotary indexing 134. As a result of operation of insertion system 80 and second imaging system 82, designated sets of sheets 101 each contain an insert providing address information to selected recipients.

Although the single-lane machine described above has been set forth with respect to particular machine components, those skilled in the art will appreciate that numerous different mechanisms exist for performing the various operations described above. For example, in addition to rotary indexing systems, other types of vertical stacking indexing systems and lateral stacking indexing systems could also be used. Further, in addition to the rotary feed and friction feed collators described above, a swing arm collator could also be used to prepare designated sets of sheets for delivery to the re-feeding system. Further, the single-lane machine described above can include additional sensing devices and electronic control and relay systems to send information to the operations controller and to receive instructions from the operations controller. Additionally, although the single-lane machine described above has been illustrated with reference to conveyor belt systems for transferring the stock sheets and designated sets of sheets, other types of conveyance mechanisms can also be used. For example, rollers, air bearing systems, vibrating systems, and the like.

Although the machine described and illustrated above sets forth an embodiment in which all machine components are linked together, those skilled in the art will appreciate that the system can be assembled as individual components. For example, a human operator or a mechanical transfer system can provide an interface between the various machine components. In an alternative embodiment, the collator can feed sets of sheets to a collection area and a human operator or a mechanical transfer system can deliver the sets of sheets to the re-feeder. Further, the sets of documents from the re-gathering system can be transported to the finishing system by a human operator or a mechanical transfer system.

Those skilled in the art will appreciate that the machine system described above can be operated under a number of different control programs. The following description sets forth several different program control sequences that can be used for the machine system described above. In accordance with the invention, the following program control sequences can also be employed to operate machine systems that differ from those described above.

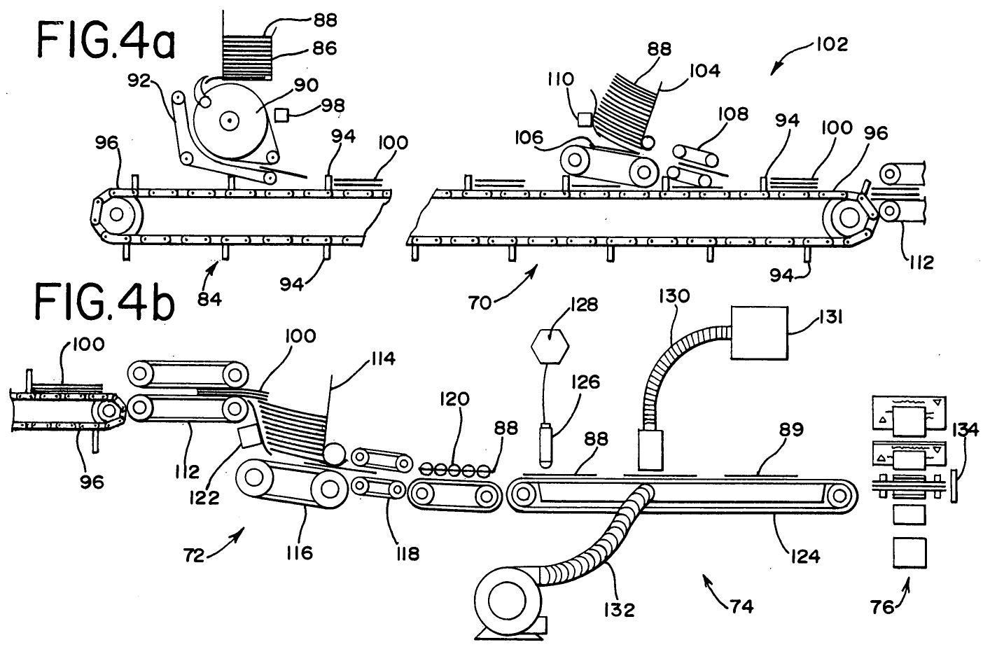

One embodiment of a process control sequence for a single-lane machine arranged in accordance with the invention is illustrated in FIG. 5. The control sequence begins by reading database information from data structure 38 into operations controller 40 at step 160. Re-feeder 72 is programmed for a maximum number of inserts at step 162. The various bins of collator 70 are activated by commands from operations controller 40 at step 164. Information regarding the number of inserts or stock sheets to be included in a designated set is relayed to re-feeder 72 at step 166. Scanning device 126 is instructed to scan each sheet for verification at step 168. Imaging control system 131 upon receiving instructions from operations controller 40 prints personalized information on the sheet at step 180. At step 182 an optional drying procedure is carried out cure the imaged sheet. The optional drying system can reside in proximity to vacuum belt 124 at a position downstream from imaging device 130. Re-gathering system 76 is instructed to index, collect and re-collate the printed sheets into the original sets of sheets at step 184. If needed, the re-collated sets of sheets can be turned over or otherwise positioned for final processing at step 186. Final processing as described above is carried out at step 188.

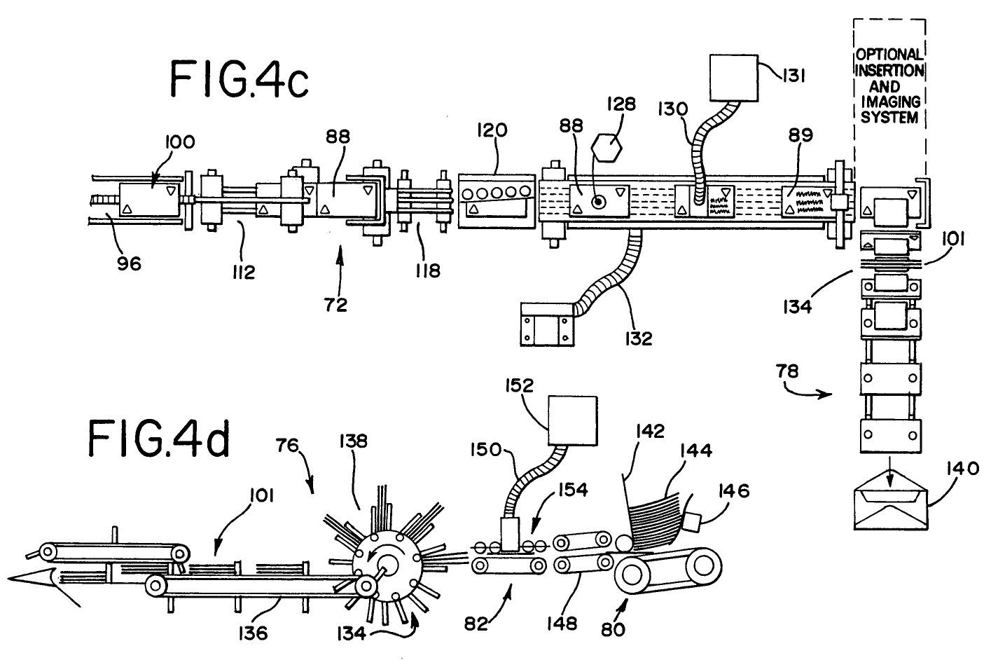

An additional embodiment of a process control sequence for the single-lane machine described above is illustrated in FIG. 6. The processing sequence illustrated in FIG. 6 is intended for use with a variable speed re-gathering system. The process sequence is similar to that illustrated in FIG. 5 with the exception that the re-feeder is not programmed for a maximum number of inserts. Steps 190 and 192 are similar to steps 160 and 164 in the process sequence described above. At step 194, operations controller 40 sends instructions to re-feeder 72 for the required number of sheets for each designated set. Steps 196, 198, and 200 are similar to steps 168, 180, and 182 described above. At step 202, the number of stock sheets in each designated set is relayed by operations controller 40 to re-gathering system 76. Electronic control within re-gathering system 76 adjusts the speed of rotary indexing system 134 according to the number of sheets required in each set. Steps 204 and 206 are similar to steps 186 and 188 described above.

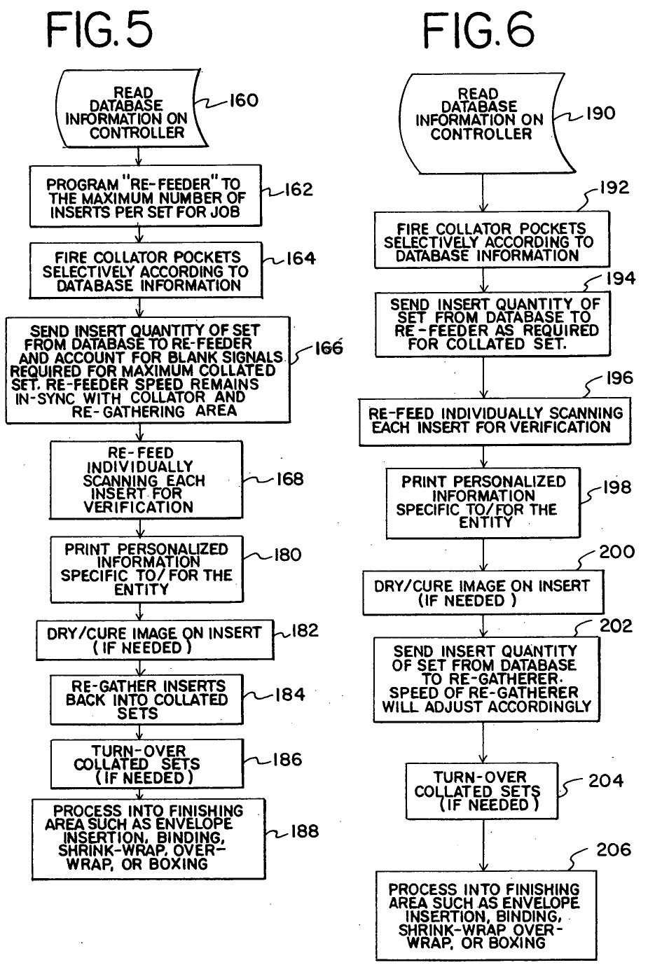

FIG. 7 illustrates a process control sequence for the single-lane machine described above in the embodiment in which the single-lane machine includes an insertion system 80 and second imaging system 82. Steps 208-224 are similar to steps 160-186 described above. At step 226, operations controller 40 instructs insertion system 80 and second imaging system 82 to provide a personalized insert sheet into the designated sets of sheets. At step 228, the insert sheet is dried in an optional drying system that can be located immediately downstream from second imaging system 82. Step 230 is similar to step 188 described above.

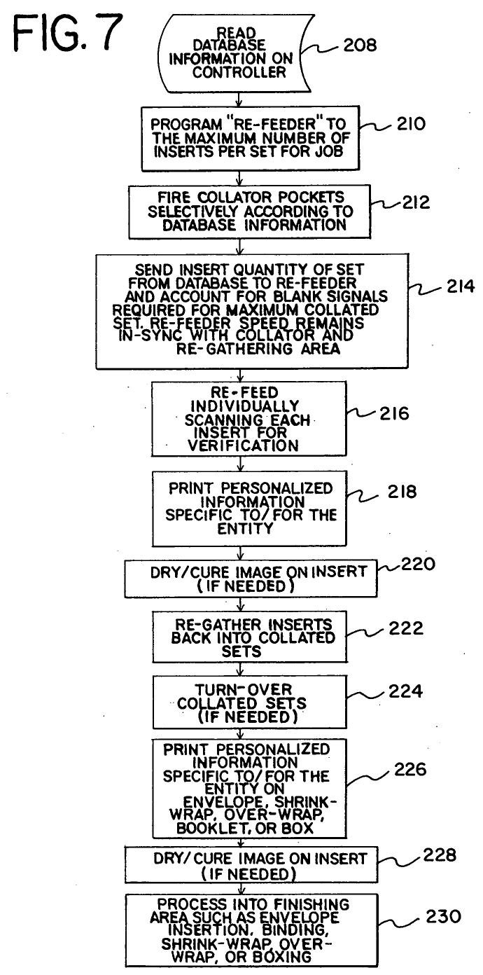

In accordance with the invention, an alternative embodiment of a system for producing personalized printed material is illustrated in FIG. 8. The system includes a first collator 232 coupled to a first re-feeder 234. A second collator 236 is coupled to a second re-feeder 238. In accordance with the invention, first collator 232 includes more bins then second collator 236. A first imaging system 240 is coupled to first re-feeder 234 and a second imaging system 242 is coupled to second re-feeder 238. The first imaging system 240 and the second imaging system 242 transfer sheets with personalized information imaged thereon to a reassembly station 244. Reassembly station 244 includes a merging station 246 where sets of sheets originating from first collator 232 and imaged with personalized information by imaging system 240 and sheets originating from second collator 236 and image with personalized information by second imaging system 242 are merged together. Merging station 246 transfers the merged sets of sheets to a final processing system 248. Final processing system 248 can include a turnover device 250 and, in one embodiment of the invention, a packaging system 252 that packages the sets of sheets in one of the packaging types described above. The packaging system is coupled to a transport system 254 that transports the packaged sets of sheets to a staging area for storage or delivery.

In accordance with the embodiment of the invention illustrated in FIG. 8, second collator 236 is loaded with stock sheets that are intended for insertion into the set of sheets to identify special matters to be included within the designated sets of sheets. For example, the stock sheet loaded in second collator 236 can be generic sheets that are intended to be inserted within all designated sets of sheets that are produced under one or more job requests.

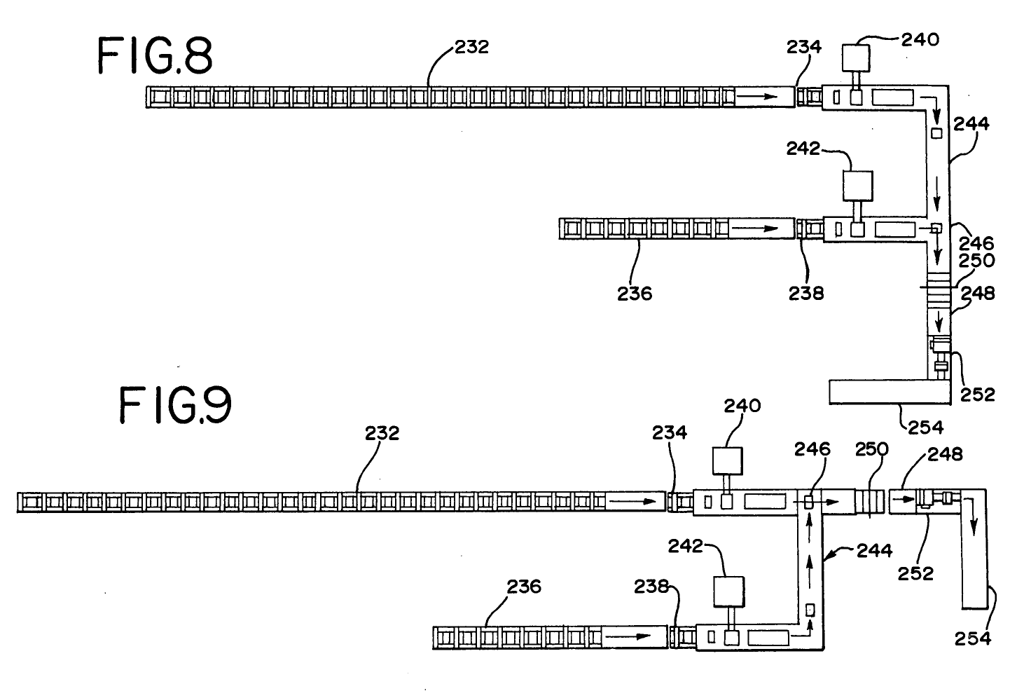

In accordance with the invention, yet another alternative embodiment of a system for producing personalized printed material is illustrated in FIG. 9. In similarity with the embodiment illustrated in FIG. 8, the system includes a first collator 232, a first re-feeder 234, and a first imaging system 240. Also included are a second collator 236, a second re-feeder 238, and a second imaging system 242. In the system illustrated in FIG. 9, merging station 246 is positioned in line with first collator 232. Reassembly station 244 transfer sets of sheets from second imaging system 242 to merging station 246. Final processing station 248 is also aligned with first collator 232. Those skilled in the art will recognize that other arrangements are possible for the dual-lane illustrated in FIG. 8. For example, in accordance with the invention, additional collators could be added and coupled to reassembly station 244 and their output merged at merging station 246.

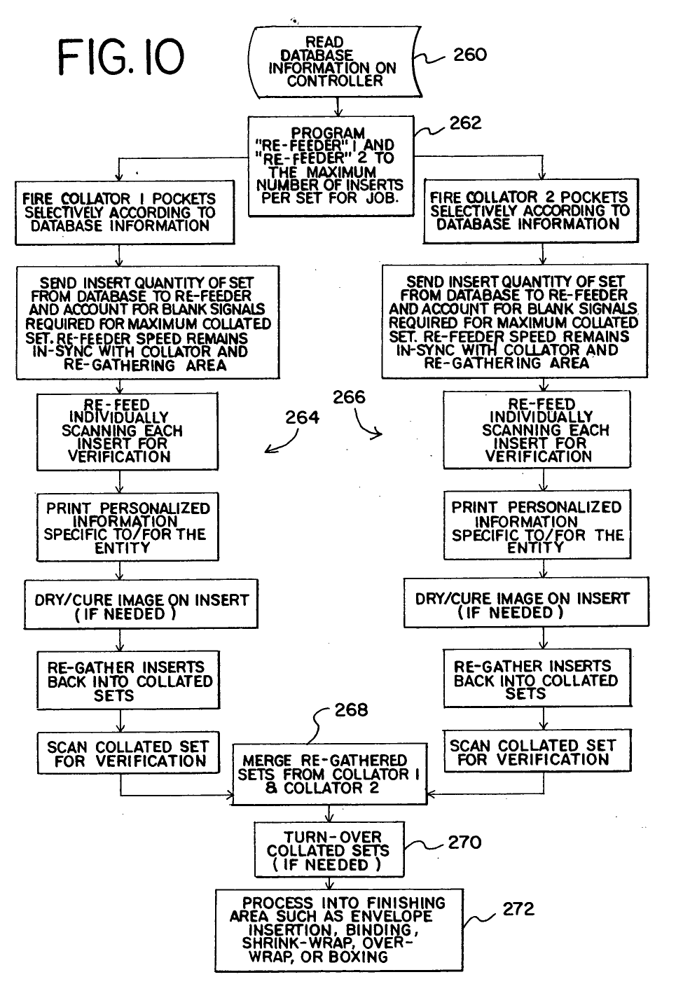

FIG. 10 illustrates a process control sequence for a dual-lane machine as illustrated in FIGS. 8 and 9. At step 260, operations controller 40 receives instructions from a system operator to assembly sets of personalized sheets according to a user job request. At step 262, first and second re-feeders 234 and 238 are programmed to assemble a maximum number of inserts or stock sheets into each designated set. Each of collators 232 and 236 are then directed according to processing command sequences 264 and 266, respectively. Each of the individual processing steps within command sequences 264 and 266 are similar to the steps previously described. At step 268, operations controller 40 instructs merging station 246 to re-gather the sheets from imaging systems 240 and 242. The merged sets of sheets are then turned over, if necessary, by a turnover system 250 at step 270. Final processing as previously described is then carried out a step 272.

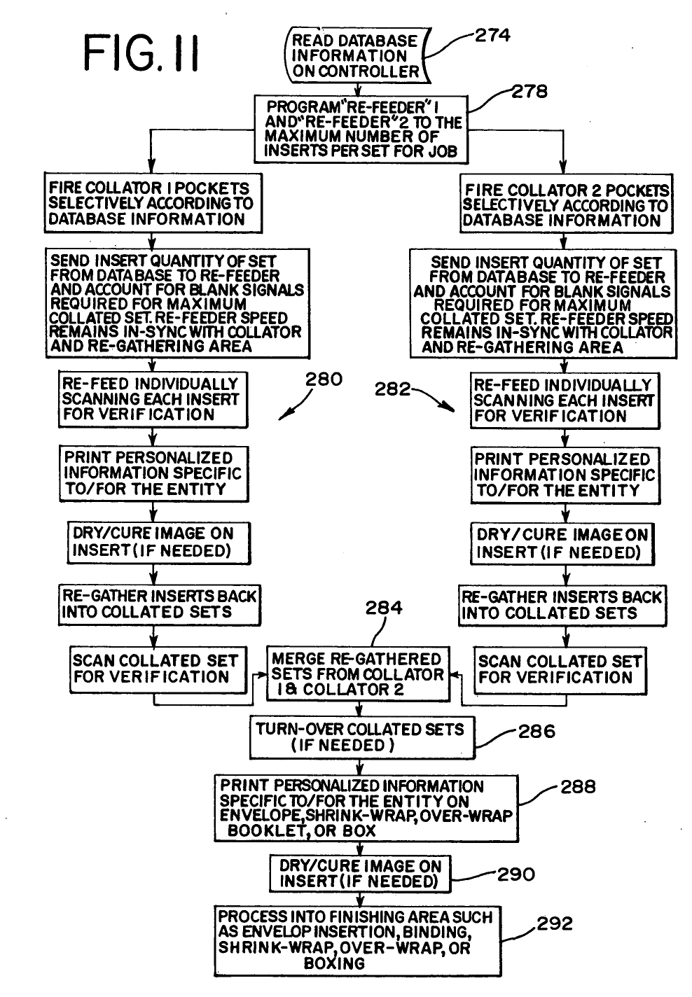

A process control sequence for a dual-lane machine in accordance with another embodiment of the invention is illustrated in FIG. 11. The processing sequence illustrated in FIG. 11 provides operating instructions for a dual-lane machine as illustrated in FIG. 8 or 9. The system, however, also includes a insertion system and imaging system as illustrated in FIG. 4d. Steps 274 and 278 are the same as steps 260 and 262 described above. Also, processing control sequences 280 and 282 are the same as processing control sequences 264 and 266. Steps 284 and 286 are the same as steps 268 and 270. At step 288 operations controller 40 instructs the insertion system and the imaging system to provide a personalized sheet for each set of sheets that can be used, for example, for addressing purposes. An optional drying step for the insert sheets is performed at step 290 and final processing is carried out at step 292.

Thus is apparent that there has been described a system and method for producing personalized imaged material that fully provides the advantages set forth above. Those skilled in the art will recognize that numerous modifications and variations can be made without departing from the spirit of the invention. For example, the collators and insertion systems can be configured to insert objects into the designated sets of sheets. The objects can include, for example, product samples, vouchers, marketing aids, such as games, and the like. Accordingly, all such variations and modifications are within the scope of the appended claims and equivalents thereof.

1. A method for producing personalized printed material comprising:
(a) selectively gathering stock sheets and assembling the stock sheets into designated sets of sheets;
(b) sequentially processing the stock sheets in each designated set of sheets to image personalized information onto each stock sheet;
(c) re-gathering the stock sheets into the designated sets of sheets; and
(d) presenting the designated sets of sheets for final processing.

2. The method of claim 1, wherein selectively gathering stock sheets and assembling the stock sheets into designated sets of sheets comprises:
(a) placing the stock sheets into individual bins of a multi-station collator;
(b) sending a control signal to designated individual bins to activate placement of selected pre stock sheets onto a transport system; and
(c) transporting the selected stock sheets to a staging area.

3. The method of claim 2, wherein placing the stock sheets into individual bins comprises placing stock sheets having predetermined indicia thereon.

4. The method of claim 3, wherein sending a control signal to designated individual bins comprises storing the predetermined indicia in a memory accessible by a control system and activating selected bins according to instructions to provide a set of stock sheets having the predetermined indicia thereon.

5. The method of claim 2, wherein placing the stock sheets into individual bins of a multi-station collator comprises placing the stock sheets into individual bins of a friction feed collating system.

6. The method of claim 2, wherein placing the stock sheets into individual bins of a multi-station collator comprises placing the stock sheets into individual bins of a vacuum and rotary collating system.

7. The method of claim 2, wherein placing the stock sheets into individual bins of a multi-station collator comprises placing the stock sheets into individual bins of swing arm collating system.

8. The method of claim 1, wherein selectively gathering stock sheets and assembling the stock sheets into sets of sheets comprises assembling sets of stock sheets in which the number of stock sheets in each set varies from one set to the next, or from one group of sets to the next group of sets.

9. The method of claim 1, wherein sequentially processing the stock sheets in each designated set of sheets to image personalized information onto each stock sheet comprises:
(a) placing each stock sheet into a re-feeding system; and
(b) positioning each stock sheet within the imaging field of an imaging system.

10. The method of claim 9, wherein the method further comprises scanning each stock sheet to verify the identity of the stock sheet as properly belonging to the set of stock sheets.

11. The method of claim 9, wherein placing each stock sheet into a re-feeding system comprises transporting the designated sets of sheets from a collator at a constant transport rate to the re-feeding system, and wherein the re-feeding system operates at a rate of about 2 to 50 times faster than the transport rate of the collator.

12. The method of claim 1, wherein presenting the designated sets of sheets for final processing comprises organizing the sets of sheets into a user specified format.

13. The method of claim 12, wherein organizing the designated sets of sheets into a user specified format comprises one or more of binding, attaching, or packaging the designated sets of sheets.

14. The method of claim 12, wherein organizing the designated sets of sheets comprises packaging the designated sets of sheets by one or more of envelope stuffing, shrink wrapping, and over wrapping.

15. The method of claim 1 further comprising inserting a package insert into the designated sets of sheets before presenting the designated sets of sheets for final processing.

16. A method for producing personalized printed material comprising:
(a) assembling target information into a data base and creating general and specific information files;
(b) using the general information files to selectively collate pre-printed sheets into designated sets of sheets;
(c) individually feeding the pre-printed sheets from each designated set of sheets to an imaging system;
(d) using the specific information files to image personalized information on each pre-printed sheet;
(e) re-gathering the pre-printed sheets into the designated sets of sheets; and
(f) presenting the designated sets of sheets for final processing.

17. The method of claim 16, wherein presenting the designated sets of sheets for final processing comprises:
(a) packaging the designated sets of sheets; and
(b) using the specific information files to image address information on the packaging.

18. The method of claim 16, wherein creating general information files comprises:
(a) receiving recipient profile information; and
(b) organizing the recipient profile information into topic categories.

19. The method of claim 18, wherein using the general information files to selectively collate pre-printed sheets into designated sets of sheets comprises:
(a) selecting a particular topic from the topic categories; and
(b) identifying bins of pre-printed sheets that contain pre-printed sheets matching the particular topic.

20. The method of claim 16, wherein creating specific information files comprises:
(a) receiving recipient profile information; and
(b) organizing the recipient information into recipient data files including identification files, address files, customer specific pricing files, and one or more files containing product preference, retail store preference, and geographic location.

21. The method of claim 20, wherein using the specific information files to image personalized information on each pre-printed sheet comprises:
(a) matching job request information with one or more recipient data files; and
(b) imaging information from the one or more recipient data files onto the pre-printed sheets.

22. The method of claim 16, wherein individually feeding the pre-printed sheets from each designated set of sheets to an imaging system comprises:
(a) placing each pre-printed sheet on a transport system; and
(b) positioning each pre-printed sheet within the imaging field of an imaging system.

23. The method of claim 22, wherein positioning each pre-printed sheet within the imaging field of an imaging system comprises positioning within the imaging field of a variable data imaging system.

24. The method of claim 23, wherein positioning each pre-printed sheet within the imaging field of variable data imaging system comprises positioning within the imaging field of a laser printing system or an ink jet printing system.

25. The method of claim 16, wherein using the general information files to selectively collate pre-printed sheets into designated sets of sheets comprises:
(a) placing the pre-printed sheets into individual bins of a multi-station collator;
(b) sending a control signal to designated individual bins to activate placement of selected pre-printed sheets onto a transport system; and
(c) transporting the selected pre-printed sheets to a staging area.

26. A system for producing personalized printed material comprising:
(a) a collator coupled to a re-feeder, the collator configured to selectively gather stock sheets and to assemble the stock sheets into designated sets of sheets;
(b) an imaging system coupled to the re-feeder, the imaging system configured to image information onto the stock sheets to produce personalized sheets;
(c) a regathering system coupled to the imaging system and configured to re-gather the personalized sheets into the designated sets of sheets;
(d) a final process system coupled to the regathering system and configured to perform one or more of binding, attaching, or packaging the final sets of sheets; and
(e) a control system that provides control signals for processing and imaging the stock sheets and the personalized sheets.

27. The system of claim 26 further comprising an aligning system configured to receive individual stock sheets from the re-feeder and to align the stock sheets in a predetermined orientation for imaging the information onto the preprinted sheets.

28. The system of claim 27, wherein an imaging system comprises:
a conveyor device that receives aligned stock sheets from the alignment system;
a scanning device that scans control indicia on the stock sheets and communicates with the control system; and
a printing device that prints personalized information on the stock sheets.

29. The system of claim 26, wherein the reassembly station comprises a rotary indexing system that collects the stock sheets into the final set of sheets and a conveyor that transports the sheets to the final process system.

30. The system of claim 26 further comprising an insert injection system coupled to a second imaging system wherein the insert injection system and second imaging system are configured to place one or more additional printed sheets into the designated set of sheets in response to commands from the control system.

31. A system for producing personalized printed material comprising:
(a) a first collator coupled to a first re-feeder, the first collator configured to selectively gather pre-printed sheets and to assemble the pre-printed sheets into designated sets of primary sheets;
(b) a first imaging system coupled to the first re-feeder, the first imaging system configured to image information onto the pre-printed primary sheets;
(c) a second collator coupled to a second re-feeder, the second collator configured to selectively gather pre-printed insert sheets and to assemble the pre-printed insert sheets into designated sets of insert sheets;
(d) a second imaging system coupled to the second re-feeder, the second imaging system is configured to image information onto the pre-printed insert sheets;
(e) a reassembly station coupled to the first and second imaging systems and configured to re-gather the pre-printed primary sheets into the designated sets of primary sheets and to re-gather the pre-printed insert sheets into the designated sets of insert sheets;
(f) a merging station coupled to the reassembly station and configured to merge the designated sets of insert sheets into the designated sets of primary sheets to provide final sets of sheets; and
(g) a final process system configured to perform one or more of binding, attaching, or packaging the final sets of sheets.

32. The system of claim 31, wherein the merging station and the final processing system are arranged in a linear relationship to the first collator and first imaging system.

33. The system of claim 31, wherein the merging station and the final processing system are arranged at substantially right angles to the first and second collators and the first and second imaging systems.

34. The system of claim 31 further comprising a turn over device positioned between the merging station and the final processing system.

35. The system of claim 31, wherein the first and second collators include a plurality of bins containing the pre-printed sheets, and wherein the first collator includes a greater number of bins than the second collator.
